(19) United States
(12) Patent Application Publication
(10) Pub. No.: US 2003/0234787 A1
(43) Pub. Date: Dec. 25, 2003

(54) Athletic exchange information system

(76) Inventors: Kevin Hines, Apex, NC (US); Lin Phelps, Raleigh, NC (US)

Correspondence Address: Kevin Hines, Suite 131, 7413 Six Forks, Raleigh, NC, 27615, US

(21) Appl. No.: 10/176,328

(22) Filed: Jun. 19, 2002

(51) Int. Cl. G06T 11/20

(52) U.S. Cl. 345/440

(57) ABSTRACT

The present invention comprises a system and method for compiling athlete information for a plurality of athletes for display to a plurality of users. Real-time game events are input to an input device which generates said athlete information in a predetermined format. The formatted athlete information is then downloaded into a remote data repository accessible to a plurality of selected users. Formatted athlete information is selectively displayed to said users in response to a request by the user, the data repository queries the formatted information which allows only requested athlete information to be displayed.

### BACKGROUND

The present invention relates to information systems. More specifically, the present invention relates to an electronic data system that records, stores and manages information.

Information collection and storage is an important aspect of most businesses and for most individuals. The ability to access this information from anywhere is also important, especially where there are numerous information collection points and even more information gatherers. A centralized network of information is needed in these situations. Currently, the Internet is a method by which access to information is simply a click away.

Accessibility to information is the backbone of some industries. For example, accessibility to case law in law libraries or through data collection companies through the Internet is crucial to the practice of law. Since legal information for any locality is available through a centralized location, lawyers and others have the ability to advise their clients on matters extending outside of their jurisdiction. Another industry that utilizes a large amount of information that extends outside ones general location is sports. Athletic statistics are an integral part of the recruitment, retention and acquiring of athletes for positions on both collegiate and professional sports organizations.

Unfortunately, athletic statistics are not readily available to those involved in the recruitment of athletes. Most coaches and scouts are informed about high quality athletes through word of mouth, coaches of the athletes, news reports, all star games, etc. The problem, though, is that many athletes are missed due to lack of exposure, not talent.

Therefore, there exists a need for a system wherein individuals involved in the recruitment of athletes have access to information that can be used in making decisions on acquiring talent.

### SUMMARY

The present invention comprises a system and method for compiling athlete information for a plurality of athletes for display to a plurality of users. Real-time game events are input to an input device which generates said athlete information in a predetermined format. The formatted athlete information is then downloaded into a remote data repository accessible to a plurality of selected users. Formatted athlete information is selectively displayed to said users in response to a request by the user, the data repository queries the formatted information which allows only requested athlete information to be displayed.

### BRIEF DESCRIPTION OF THE DRAWING

FIG. 1 is a block diagram of the athletic exchange information system in accordance with the preferred embodiment of the present invention.

FIGS. 2a, 2b, 2c and 2d are example game event screens.

FIG. 3 is an example event log.

FIGS. 4a and 4b example shot charts.

FIG. 5 is an example of the formatted athlete information.

FIG. 6 is a flow diagram of the method of the present invention.

### DESCRIPTION OF THE PREFERRED EMBODIMENTS

The present invention will be described in relation to the drawing figures wherein like numerals represent like components throughout.

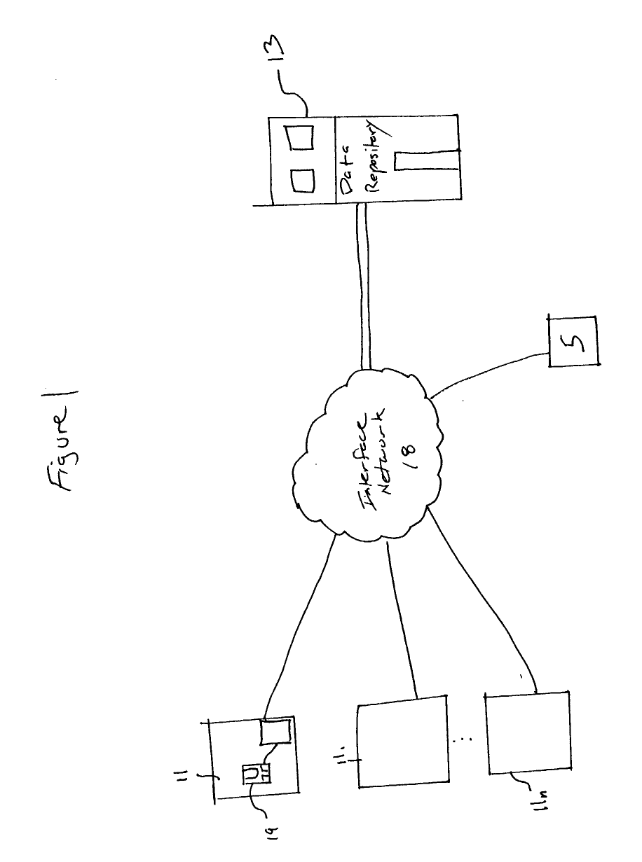

FIG. 1 is a block diagram of the athletic exchange information system 10 in accordance with the preferred embodiment of the present invention. The system 10 comprises a plurality of subscribers 11ₗ . . . 1ₙ, a data repository (DR) 13 and an interface network 18. Subscribers 11ₗ . . . 11ₙ to the system 10 access the data repository 13 through the interface network 18. The interface network, for purposes of this disclosure is a wide area network, such as the Internet including an interactive web interface. As those skilled in the art know, any interface network which provides access to subscribers remote to the data repository 13 may be used.

The DR 13, coupled to the network 18, stores the information received through the network 18 and uploads the information when requested by a subscriber 11, to be disclosed hereinafter. The information that is stored in the DR 13 can be queried by a subscriber 11 for display over the network 18. An example of the information that is stored in the DR 13 is athlete stats, for example, but not limited to, points scored in a game, rebounds made in a game, freethrows made and attempted, shots taken and made, etc. Athlete information for individual athletes will be described in relation to basketball players, although all information relating to athletes in all sports may be stored in the DR 13. For ease of disclosure, basketball athletes will be used in the explaining the preferred embodiment of the present invention. Athlete information from the DR 13 is forwarded to the network 18 to be displayed for a user 5, to be disclosed hereinafter. Also, information downloaded by the subscriber 11 is forwarded to the DR 13 over the network 18, to be disclosed hereinafter.

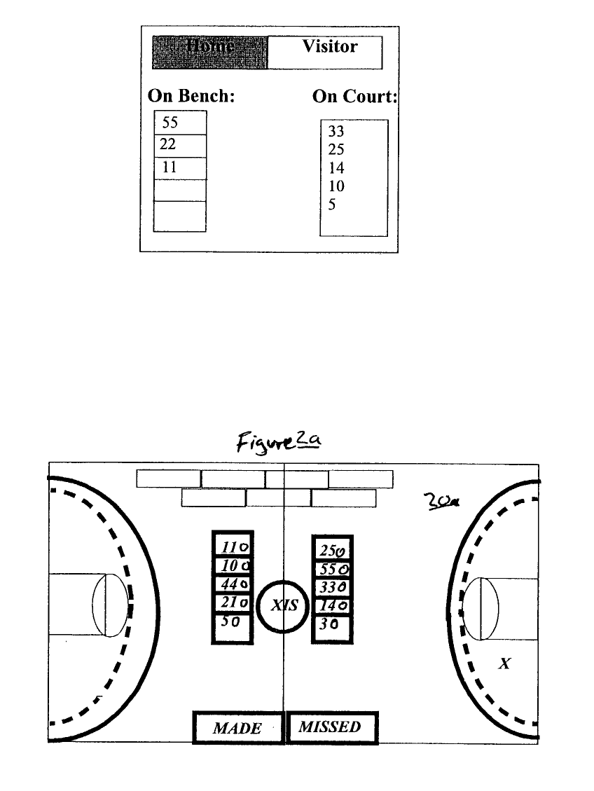

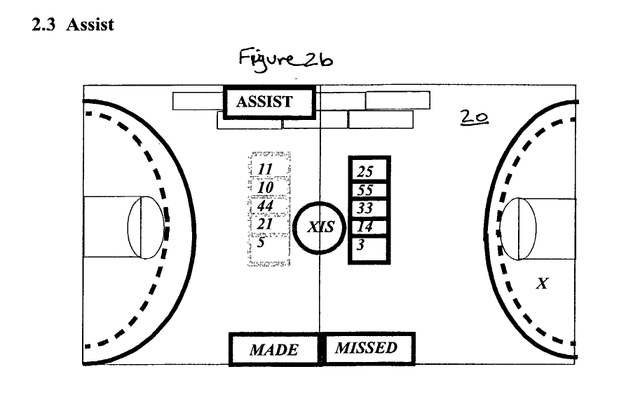

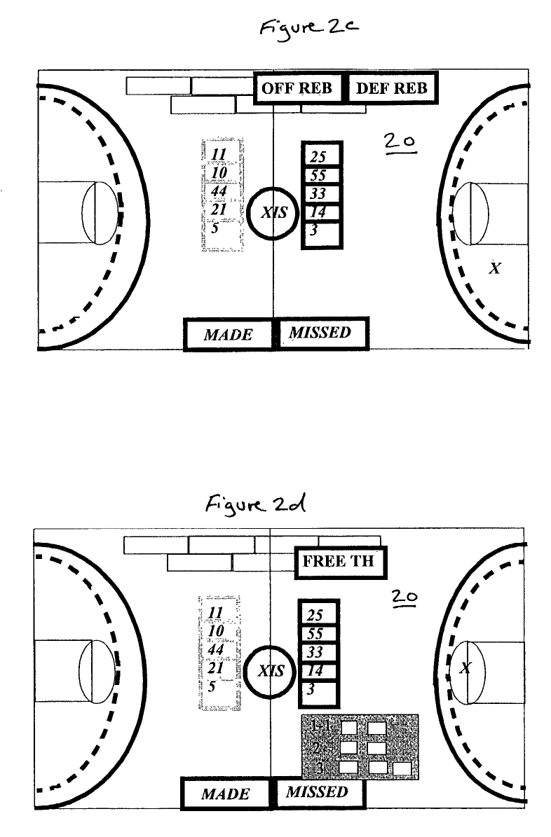

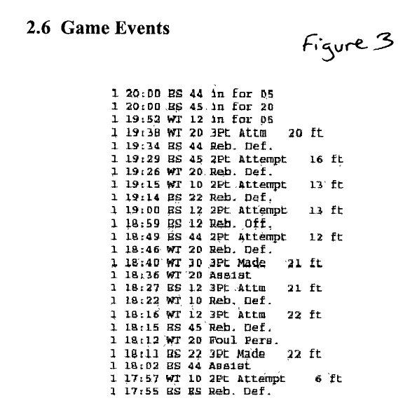

The subscriber 11, coupled to the network 18, comprises a subscriber server 12 and an input device 19. As will be disclosed hereinafter, the input device 19 provides the subscriber with an improved ability to generate athlete information automatically. The input device 19 is used by the subscriber 11 to input real-time game events, such as shots attempted, assists, rebounds, etc., for each player associated with a subscriber 11. The input device 19, for example, may be a hand held personal digital assistant (PDA) or a laptop computer. Although, a PDA will be used to describe the preferred embodiment, any input device 19 may be used. FIG. 2 is an example screen display of the input device used by the subscriber 11 to input the game events.

FIG. 2a is an example display of the input device 19 of the shots taken screen wherein stats regarding shot attempts are generated. For example, if player 110 shoots the ball, the subscriber 11 touches the players number on the touch screen 20, then touches where on the basketball court the player shot the ball and then touches the made or missed button depending on the result. If the shot is made by the player 110, the Assist button at the top of the touch screen 20 is highlighted and the defensive team roster becomes gray. This protects against the subscriber 11 making a mistake as to which team the player with the assist is associated. The subscriber 11 then may select the player who made the assist or touch anywhere on the screen to indicate that the shot was made without an assist. An example drawing of the ASSIST screen is illustrated in FIG. 2b.

Illustrated in FIG. 2c is an example touch screen 20 wherein Offensive and Defensive rebound stats are generated. When a missed shot is recorded by the subscriber, the OFF/DEF Rebound screen automatically is prompted. The subscriber then touches the appropriate highlighted box, OFF REB or DEF REB, then selects the player on the associated team that made the rebound. As stated above in relation to the Assist screen, when there is an offensive rebound, the defensive team roster becomes gray, vice versa, when there is a defensive rebound.

Illustrated in FIG. 2d is an example touch screen 20 wherein Free Throw stats are generated. The free throw touch screen is generated when the subscriber 11 touches the FREE TH button on the touch screen 20. The subscriber 11 then has the option of choosing 1-1, 2-shot or 3-shot foul. Each time a free throw is taken, the subscriber 11 then touches the appropriate box labeled MADE or MISSED.

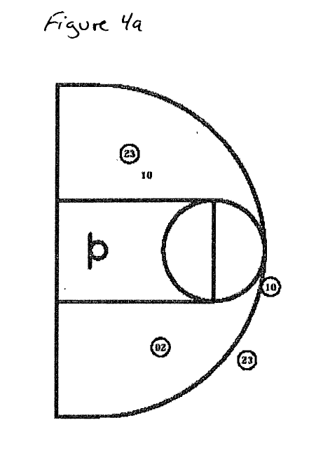

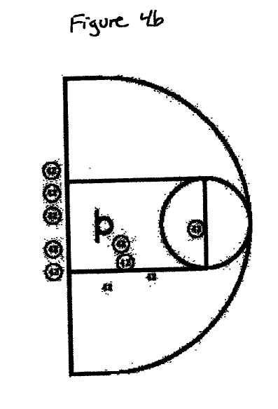

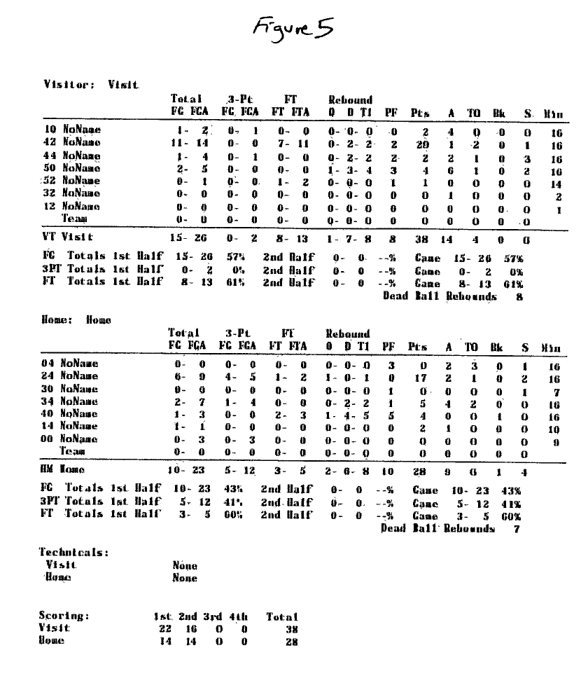

The events of the game are logged with the play-by-play button given on the main screen (not shown) and highlighted for deletion or correction. An example event log is illustrated in FIG. 3. The team shot chart and the individual shot chart are recorded during the game and may be viewed at anytime during or after its conclusion. An illustration of the two respective charts are shown in FIGS. 4a and 4b, respectively. The shot charts records and stores the shot selection of the entire team. As an example, the shots that are made are recorded as a circle with the players number inside. Those shots that are missed are indicated by a players jersey number without the circle.

The events that are logged are formatted as disclosed above to generate the player stats for upload to the DR. An illustration of the total formatted athlete stat information for a game is shown in FIG. 5. This format allows the stat information to be viewed and queried by a user over the interface network 18. Accordingly, once the game has ended, the stats are downloaded from the input device 19 to the subscriber server 12.

The subscriber server 12, coupled to the input device 19 and the interface network 18, receives the athlete information from the input device 19 and transforms the stats into a form that can be forwarded to the DR through the IP network. Each stat forwarded to the subscriber server is parsed allowing the stat information to be queried by a user through the DR 13. The athlete information associated with the subscriber 11, in a format usable by the DR, is then downloaded to the DR 13 through the interface network 18.

The DR 13, coupled to the interface network 18 and the user 5, receives the formatted stats and updates the database with the new information for each of the players associated with a subscriber 11. For example, a Subscriber A has a basketball team with player code numbers 0001-00020. Therefore, when the Subscriber A downloads the stats from a game, the DR 13 updates the stats for each player on the team in accordance with the received player code numbers. The DR 13 is able to be queried by a user 5 for any stats that are stored in the DR 13.

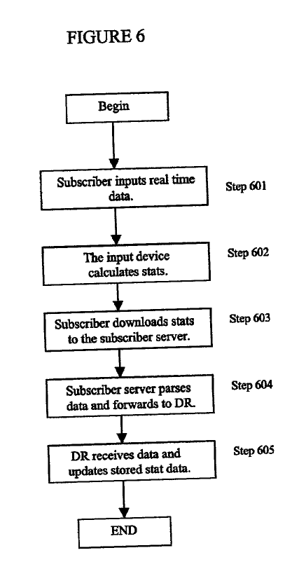

The flow diagram for a subscriber to automatically generate stats for each of the players on the team and make that information available to users is illustrated in FIG. 6. During a game, for example a basketball game, a subscriber uses the touch screen of an input device, such as a PDA, to input real time data that will generate stats for each player on the subscriber's team (Step 601). Each time the subscriber uses the touch screen to input real time game data, the input device calculates any of a plurality of stats (Step 602). Once the game has ended, the subscriber then connects the input device to the subscriber server and downloads the real time stats for each of the players (Step 603). The subscriber server then parses the stats for each of the players into separate data files and forwards the information to the DR through the IP network (Step 604). The DR receives the formatted stat information for each player code number associated with the subscriber and updates the stat data stored therein using the received information (Step 605).

As stated hereinabove, the athlete stat information is stored by the DR is a format that is able to be viewed and queried by a user. A user, through the IP network, a website for example, accesses the DR using a password. The user then may query the DR in order to view players that meet a standard set by the user, for instance, the user may want all high school players that average 25 points per game. The DR, in response to the user's request, runs a query on the athlete stat information and displays all of the high school players that meet the criteria set by the user. The user may narrow the viewed information further by adding another query parameter.

The system of the present invention provides users with real-time access to athlete stat information without relying on word-of-mouth, newspapers, coaches, etc. It gives everyone access to the same information, allowing coaches and team management to make informed decisions regarding personnel recruitment and retention. The system also provides athletes exposure to recruiters and scouts no matter where the athlete is located.

The above description and the views and material depicted by the figures are for purposes of illustration only and are not intended to be, and should not be construed as, limitations on the invention. Moreover, certain modifications or alternatives may suggest themselves to those skilled in the art upon reading of this specification, all of which are intended to be within the spirit and scope of the present invention as defined in the attached claims.

We claim:

1. A system for compiling a athlete information for a plurality of athletes comprising:
an input device for inputting real-time game events and generating said athlete information from said inputs, said athlete information being in a predetermined format;
a remote data repository for receiving said formatted athlete information; and
a network interface, coupled to said input device and said data repository, for selectively displaying said formatted athlete information, whereby said data repository queries said athlete information in response to a request by a user.

2. A method for compiling athlete information for a plurality of athletes for display to a plurality of users comprising the steps of:
inputting real-time game events in an input device and generating said athlete information from said inputs, said athlete information being in a predetermined format;
downloading said formatted athlete information to a remote data repository;
selectively displaying said formatted athlete information in response to a request by a user, said data repository querying said formatted information, allowing only requested athlete information to be displayed.
